(19) United States
(12) Patent Application Publication
(10) Pub. No.: US 2015/0361227 A1
(43) Pub. Date: Dec. 17, 2015

(54) PARTICULATE MICROCAPSULE COMPOSITION

(71) Applicant: BASF SE, Ludwigshafen (DE)

(72) Inventors: Marco SCHMIDT, Speyer (DE); Tina SCHROEDER-GRIMONPONT, Jockgrim (DE); Regina KLEIN, Speyer (DE); Joachim PAKUSCH, Speyer (DE)

(73) Assignee: BASF SE, Ludwigshafen (DE)

(21) Appl. No.: 14/763,983

(22) PCT Filed: Jan. 22, 2014
(86) PCT No.: PCT/EP14/51218

§ 371 Date: Jul. 28, 2015

(30) Foreign Application Priority Data
Feb. 25, 2013 (EP) 13156551.7

(51) Int. Cl. C08J 3/16; B29C 45/00; B29B 9/12; B29C 47/00; C08J 3/20; B29B 9/10

(52) U.S. Cl. CPC C08J 3/16; C08J 3/203; B29B 9/10; B29B 9/12; B29C 47/0004; B29C 47/0023; B29C 47/0021; B29C 47/003; B29C 45/0013; B29C 45/0001; C08J 2333/12; C08J 2433/12; C08J 2433/06; B29B 2009/125; B29K 2023/00

(57) ABSTRACT

The present invention relates to particulate microcapsule compositions comprising microcapsules and an emulsion polymer, obtainable via spray drying of an aqueous microcapsule dispersion, where the microcapsules comprise a capsule core and a polymer as capsule wall and the polymer is composed of

from 30 to 90% by wt. of one or more monomers (monomers I) from the group consisting of C₁-C₂₄-alkyl esters of acrylic and/or methacrylic acid, acrylic acid, methacrylic acid, and maleic acid,

from 10 to 70% by wt. of one or more ethylenically unsaturated monomers having two, three, four, or more ethylenically unsaturated moieties (monomers II), and

from 0 to 40% by wt. of one or more other monomers (monomers III), based in each case on the total weight of the monomers,

with use of an aqueous dispersion of one or more emulsion polymers which comprises in copolymerized form

from 50 to 99.9% by wt. of esters of acrylic and/or methacrylic acid with alkanols having from 1 to 12 carbon atoms and/or styrene, or

from 50 to 99.9% by wt. of styrene and/or butadiene, or

from 50 to 99.9% by wt. of vinyl chloride and/or vinylidene chloride, or

from 50 to 99.9% by wt. of vinyl acetate, vinyl propionate, vinyl esters of versatic acid, vinyl esters of long-chain fatty acids, and/or ethylene,

as spraying aid, to a process for producing these, and also to their use for producing thermoplastic moldings.

The present invention relates to particulate microcapsule compositions comprising microcapsules and an emulsion polymer, obtainable via spray drying of an aqueous microcapsule dispersion, where the microcapsules comprise a capsule core and a polymer as capsule wall and the polymer is composed of

from 30 to 90% by wt. of one or more monomers (monomers I) chosen from C₁-C₂₄-alkyl esters of acrylic and/or methacrylic acid, acrylic acid, methacrylic acid, and maleic acid,

from 10 to 70% by wt. of one or more ethylenically unsaturated monomers having two, three, four, or more ethylenically unsaturated moieties (monomers II), and

from 0 to 40% by wt. of one or more other monomers (monomers III),

based in each case on the total weight of the monomers,

with use of an aqueous dispersion of one or more emulsion polymers which comprises in copolymerized form

from 50 to 99.9% by wt. of esters of acrylic and/or methacrylic acid with alkanols having from 1 to 12 carbon atoms and/or styrene, or

from 50 to 99.9% by wt. of styrene and/or butadiene, or

from 50 to 99.9% by wt. of vinyl chloride and/or vinylidene chloride, or

from 50 to 99.9% by wt. of vinyl acetate, vinyl propionate, vinyl esters of versatic acid, vinyl esters of long-chain fatty acids, and/or ethylene,

as spraying aid, to a process for producing these, and also to their use for producing thermoplastic moldings.

Recent years have seen a wide variety of developments in the field of microencapsulated latent heat accumulators. The latent heat accumulators are often also called PCM (phase change material) and they function by using the enthalpy that arises during the solid/liquid phase transition and that implies energy absorption or energy dissipation to the environment. They can thus be used to keep temperature constant within a defined temperature range. It is moreover known from WO2009/080232 that the refractive index difference between solid and liquid core material can be utilized for optical effects in polymeric matrix materials. The requirements placed upon the microcapsules here are different in different application sectors, and this in particular applies to the polymeric capsule wall thereof, since escape of the core material is undesirable and would lead to a decrease in the respective effect.

These microencapsulated latent heat accumulator materials are often used in the form of aqueous dispersion or else in the form of microcapsule powder. The microcapsule powder here is generally obtained via spray-drying of a microcapsule dispersion. In order to improve handling properties here, it is usual to use spraying aids which lead to formation of relatively large aggregates of individual capsules during the spray-drying process.

WO 2006/092439 teaches large-particle microcapsule powders with an average particle size in the range from 150-400 μm which are obtained by means of spray-drying with water-soluble polymers of polyvinyl alcohol type and partially hydrolyzed polyvinyl acetates and methylhydroxypropylcellulose as spraying aids. Since there is often a requirement for subsequent redispersion in an aqueous system, spraying aids used are exclusively those with good water-solubility.

WO 2006/077056 teaches granulates made of microencapsulated latent heat accumulator material and of film-forming polymeric binders with a glass transition temperature in the range from 40 to 120° C. The average particle size of the granulates varies in the range from 200 μm up to 5 mm, and it is primarily the use of extrusion to produce mm-size granulates that is described. Production in a fluidized-bed granulator is also described, as a variant of granulate production.

WO 2012/069976 teaches the production of a thermoplastic molding composition comprising microencapsulated latent heat accumulator materials. According to this teaching, the microcapsules are introduced at a late juncture in the plastifying section of the extruder, in order to minimize thermal stress. The resultant polymer blends can be used to produce fibers, foils, and moldings.

Processing together with a thermoplastic requires the use of microcapsule powder. However, the use of spray-dried microcapsule powder of the prior art reveals that individual microcapsules are not obtained within the thermoplastic.

It was therefore an object of the present invention to provide microcapsule powders in a supply form which firstly permits processing of the solid without dusting and secondly can be incorporated advantageously within thermoplastics, and in particular leads to maximum uniformity of dispersion of separate microcapsules.

Accordingly, the particulate microcapsule compositions defined in the introduction have been found, as also have a process for producing these and their use for producing thermoplastic moldings.

The particulate microcapsule compositions of the invention are aggregates made of microcapsules, known as the primary particles, and of the emulsion polymer. Particles of this type are often called granulate or agglomerate. The surface of the particulate microcapsule composition here can be uneven or else spherical or ovoid.

The microcapsules used in the invention comprise a capsule core made of lipophilic substance and a capsule wall made of polymer. The capsule core is composed primarily, to an extent of more than 90% by weight, of lipophilic substance. The physical condition of the capsule core here depends on the temperature and can be either solid or liquid.

A protective colloid is generally incorporated concomitantly into the capsule wall in the production process, and is therefore likewise a constituent of the capsule wall. In particular, the surface of the polymer generally comprises the protective colloid: up to 10% by weight, based on the total weight of the microcapsules, can therefore be protective colloid.

The mean particle size D[4,3] of the microcapsules used in the invention, i.e. of the primary particles (volume mean, determined by means of light scattering), is from 0.5 to 50 μm, preferably from 0.5 to 20 μm, in particular from 1 to 10 μm. The ratio by weight of capsule core to capsule wall is generally from 50:50 to 95:5. Preference is given to a core/wall ratio of from 70:30 to 93:7.

Examples of lipophilic substances are:

Aliphatic hydrocarbon compounds, e.g. branched or preferably linear, saturated or unsaturated C₁₀-C₄₀-hydrocarbons, aromatic hydrocarbon compounds, saturated or unsaturated C₆-C₃₀-fatty acids, fatty alcohols, and also what are known as oxo alcohols, obtained via hydroformylation of α-olefins and further reactions, ethers of fatty alcohols, C₆-C₃₀-fatty amines, esters, e.g. C₁-C₁₀-alkyl esters of fatty acids, e.g. propyl palmitate, methyl stearate, or methyl palmitate, and also preferably their eutectic mixtures, or methyl cinnamate, natural and synthetic waxes, and the halogenated hydrocarbons listed in WO 2009/077525, the disclosure of which is expressly incorporated herein by way of reference.

It is advantageous by way of example to use pure n-alkanes, n-alkanes with a purity of more than 90%, or the alkane mixtures produced as industrial distillate and commercially available as such.

It can moreover be advantageous to add, to the lipophilic substances, compounds which are soluble therein, in order to avoid the crystallization delay which sometimes occurs with the nonpolar substances. As described in U.S. Pat. No. 5,456,852, it is advantageous to use compounds whose melting point is higher by from 20 to 120 K than that of the actual core substance. Suitable compounds are the substances mentioned above as lipophilic substances in the form of fatty acids, fatty alcohols, fatty amides, and also aliphatic hydrocarbon compounds. The amounts of these, based on the capsule core, are from 0.1 to 10% by weight.

It is preferable that the lipophilic substance is a mixture which comprises a wax. The invention uses an amount of from 1 to 5% by weight, preferably from 1 to 3% by weight, of the wax with a melting point ≧40° C., based on the total amount of lipophilic substance. Waxes of this type are described in WO 2012/110443, which is expressly incorporated herein by way of reference. The addition of the wax with a melting point ≧40° C. avoids the crystallization delay that sometimes occurs with the nonpolar substances. Suitable compounds that may be mentioned as examples of waxes with a melting point ≧40° C. are Sasolwax 6805, British Wax 1357, stearic acid, and chloroparaffins.

The polymers of the capsule wall generally comprise, in copolymerized form, at least 30% by weight, preferably at least 40% by weight, particularly preferably at least 50% by weight, in particular at least 55% by weight, very particularly preferably at least 70% by weight, and up to 90% by weight, preferably at most 85% by weight and very particularly preferably at most 80% by weight, of at least one monomer from the group consisting of C₁-C₂₄-alkyl esters of acrylic and/or methacrylic acid, acrylic acid, methacrylic acid, and maleic acid (monomers I), based on the total weight of the monomers.

The polymers of the capsule wall moreover comprise, in copolymerized form, at least 10% by weight, preferably at least 15% by weight, with preference at least 20% by weight, and generally at most 70% by weight, preferably at most 60% by weight, and particularly preferably at most 50% by weight, in particular at most 45% by weight, of one or more ethylenically unsaturated monomers having two, three, four or more ethylenically unsaturated moieties (monomers II), based on the total weight of the monomers. It is preferable that the polymers of the capsule wall comprise, in copolymerized form, as monomers II, monomers having three, four, or more ethylenically unsaturated moieties.

The polymers can also comprise, in copolymerized form, up to 40% by weight, preferably up to 30% by weight, in particular up to 20% by weight, of other monomers III. It is preferable that the capsule wall is composed only of monomers of the groups I and II.

Suitable monomers I are C₁-C₂₄-alkyl esters of acrylic and/or methacrylic acid, and also the unsaturated C₃- and C₄-carboxylic acids such as acrylic acid, methacrylic acid, and maleic acid. Suitable monomers I are isopropyl, isobutyl, sec-butyl, and tert-butyl acrylate and the corresponding methacrylates, and also particularly preferably methyl, ethyl, n-propyl, and n-butyl acrylate and the corresponding methacrylates. Preference is generally given to the methacrylates and methacrylic acid.

Suitable monomers II are ethylenically unsaturated monomers which have two, three, four, or more ethylenically unsaturated moieties. The expression “ethylenically unsaturated monomers having two, three, four, or more ethylenically unsaturated moieties” means monomers which have unconjugated ethylenic double bonds. They bring about crosslinking of the capsule wall during the polymerization process. It is possible to copolymerize one or more monomers having two unconjugated ethylenic double bonds (divinyl monomers), and/or one or more monomers having three, four, or more unconjugated ethylenic double bonds. It is preferable to use monomers having vinyl, allyl, acrylic, and/or methacrylic groups. Preference is given to monomers which are not, or are sparingly, water-soluble, but which have good to restricted solubility in the lipophilic substance. The expression “sparingly soluble” means solubility smaller than 60 g/l at 20° C.

Suitable divinyl monomers are divinylbenzene and divinylcyclohexane. Preferred divinyl monomers are the diesters of diols with acrylic acid or methacrylic acid, and also the diallyl and divinyl ethers of said diols. Examples that may be mentioned are ethanediol diacrylate, ethylene glycol dimethacrylate, butylene glycol 1,3-dimethacrylate, methallylmethacrylamide, allyl acrylate, and allyl methacrylate. Particular preference is given to propanediol diacrylate, butanediol diacrylate, pentanediol diacrylate, and hexanediol diacrylate, and the corresponding methacrylates.

Preferred monomers having three, four, or more unconjugated ethylenic double bonds are the esters of polyhydric alcohols with acrylic acid and/or methacrylic acid, and also the allyl and vinyl ethers of these polyhydric alcohols, trivinylbenzene, and trivinylcyclohexane. Particular polyhydric alcohols that may be mentioned here are trimethylolpropane and pentaerythritol. Particular preference is given to trimethylolpropane triacrylate and trimethylolpropane trimethacrylate, pentaerythritol triallyl ether, pentaerythritol tetraallyl ether, pentaerythritol triacrylate, and pentaerythritol tetraacrylate, and also technical mixtures of these. In technical mixtures, pentaerythritol tetraacrylate is generally in a mixture with pentaerythritol triacrylate and with relatively small amounts of oligomerization products.

Preference is given to the combinations of divinyl monomers and monomers having three, four, or more unconjugated ethylenic double bonds, for example of butanediol diacrylate and pentaerythritol tetraacrylate, hexanediol diacrylate and pentaerythritol tetraacrylate, butanediol diacrylate and trimethylolpropane triacrylate, and also hexanediol diacrylate and trimethylolpropane triacrylate. Preferred combinations are in particular those in which at least 80% by weight, based on the monomers II, are one or more monomers having three, four, or more ethylenically unsaturated moieties.

Monomers III that can be used are other monomers which differ from the monomers I and II, e.g. vinyl acetate, vinyl propionate, vinylpyridine, and styrene, or α-methylstyrene, and also, as particularly preferred monomers, itaconic acid, vinylphosphonic acid, maleic anhydride, 2-hydroxyethyl acrylate and 2-hydroxyethyl methacrylate, acrylamido-2-methylpropanesulfonic acid, methacrylonitrile, acrylonitrile, methacrylamide, N-vinylpyrrolidone, N-methylolacrylamide, N-methylolmethacrylamide, dimethylaminoethyl methacrylate, and diethylaminoethyl methacrylate.

It is preferable to select microcapsules with a capsule wall composed of

from 40 to 90% by wt. of one or more C₁-C₂₄-alkyl esters of acrylic and/or methacrylic acid (monomers I),

from 10 to 60% by wt. of one or more ethylenically unsaturated monomers having two, three, four, or more ethylenically unsaturated moieties (monomers II), where at least 80% by weight, based on monomer II, are one or more monomers having three, four, or more ethylenically unsaturated moieties, and

from 0 to 30% by wt. of one or more monoethylenically unsaturated monomers (monomers III) which differ from the monomers I, based in each case on the total weight of the monomers.

It is preferable to select microcapsules with a capsule wall composed of

from 50 to 70% by wt. of one or more C₁-C₂₄-alkyl esters of acrylic and/or methacrylic acid (monomers I),

from 30 to 50% by wt. of one or more ethylenically unsaturated monomers having three, four, or more ethylenically unsaturated moieties (monomers II), and

from 0 to 20% by wt. of one or more monoethylenically unsaturated monomers (monomers III) which differ from the monomers I, based in each case on the total weight of the monomers.

The microcapsules used in the invention can be produced via what is known as in-situ polymerization. The principle of formation of the microcapsules is based on production, from the monomers, free-radical initiator, protective colloid, and from the lipophilic substance to be encapsulated, of an oil-in-water emulsion in which the monomers and the lipophilic substance take the form of disperse phase. In one embodiment it is possible to delay addition of the free-radical initiator until after the dispersion process. The polymerization of the monomers is then induced via heating, and is optionally controlled via further temperature increase, whereupon the resultant polymers form the capsule wall enclosing the lipophilic substance. This general principle is described by way of example in DE-A-10 139 171, expressly incorporated herein by way of reference.

The microcapsules are generally produced in the presence of at least one organic and/or inorganic protective colloid. Organic, and also inorganic, protective colloids can be ionic or neutral. Protective colloids here can be used either individually or else in mixtures of a plurality of identically or differently charged protective colloids. It is preferable to produce the microcapsules in the presence of an inorganic protective colloid, in particular in combination with an organic protective colloid.

Organic protective colloids are preferably water-soluble polymers which lower the surface tension of the water from 73 mN/m at most to from 45 to 70 mN/m, and thus ensure formation of coherent capsule walls, and form microcapsules with preferred particle sizes in the range from 0.5 to 50 μm, preferably from 0.5 to 30 μm, in particular from 0.5 to 10 μm.

Organic anionic protective colloids are sodium alginate, polymethacrylic acid and copolymers thereof, the copolymers of sulfoethyl acrylate and of sulfoethyl methacrylate, of sulfopropyl acrylate and of sulfopropyl methacrylate, of N-sulfoethylmaleimide, of 2-acrylamido-2-alkylsulfonic acids, of styrenesulfonic acid, and of vinylsulfonic acid. Preferred organic anionic protective colloids are naphthalenesulfonic acid and naphthalenesulfonic acid-formaldehyde condensates, and also especially polyacrylic acids and phenolsulfonic acid-formaldehyde condensates.

Examples of organic neutral protective colloids are cellulose derivatives, such as hydroxyethylcellulose, methylhydroxyethylcellulose, methylcellulose, and carboxymethylcellulose, polyvinylpyrrolidone, vinylpyrrolidone copolymers, gelatins, gum arabic, xanthan, casein, polyethylene glycols, polyvinyl alcohol, and partially hydrolyzed polyvinyl acetates, and also methylhydroxypropylcellulose. Preferred organic neutral protective colloids are polyvinyl alcohol and partially hydrolyzed polyvinyl acetates, and also methylhydroxy(C₁-C₄)alkylcellulose.

Preference is given to use of combinations of an SiO₂-based protective colloid and of a methylhydroxy-(C₁-C₄)-alkylcellulose. It has been found here that the combination with a methylhydroxy-(C₁-C₄)-alkylcellulose with an average molar mass (weight average) ≦50 000 g/mol, preferably in the range from 5000 to 50 000 g/mol, preferably from 10 000 to 35 000 g/mol, in particular from 20 000 to 30 000 g/mol, is advantageous.

The expression “methylhydroxy-(C₁-C₄)-alkylcellulose” means methylhydroxy-(C₁-C₄)-alkylcellulose having a very wide variety of degrees of methylation and also of degrees of alkoxylation. The preferred methylhydroxy-(C₁-C₄)-alkylcelluloses have an average degree of substitution DS of from 1.1 to 2.5 and a molar degree of substitution MS of from 0.03 to 0.9.

An example of a suitable methylhydroxy-(C₁-C₄)-alkylcellulose is methylhydroxyethylcellulose or methyihydroxypropylcellulose. Particular preference is given to methylhydroxypropylcellulose. Methylhydroxy-(C₁-C₄)-alkylcelluloses of this type are obtainable by way of example with trademark Culminal® from Hercules/Aqualon.

Inorganic protective colloids are solid inorganic particles, known as Pickering systems. This type of Pickering system can be composed of the solid particles alone or also of auxiliaries which improve the dispersibility of the particles in water or the wettability of the particles by the lipophilic phase. The mode of action and use thereof is described in EP-A-1 029 018 and EP-A-1 321 182, the content of which is expressly incorporated by way of reference.

The solid inorganic particles can be metal salts, such as salts, or oxides and hydroxides, of calcium, magnesium, iron, zinc, nickel, titanium, aluminum, silicon, barium, and manganese. Mention may be made of magnesium hydroxide, magnesium carbonate, magnesium oxide, calcium oxalate, calcium carbonate, barium carbonate, barium sulfate, titanium dioxide, aluminum oxide, aluminum hydroxide, and zinc sulfide. Mention may also be made of silicates, bentonite, hydroxyapatite, and hydrotalcites. Particular preference is given to SiO₂-based silicas, magnesium pyrophosphate, and tricalcium phosphate.

Suitable SiO₂-based protective colloids are fine-particle silicas. They can be dispersed in the form of fine, solid particles in water. However, it is also possible to use what are known as colloidal dispersions of silica in water. These colloidal dispersions are alkaline, aqueous mixtures of silica. In the alkaline pH range, the particles are in swollen form and are stable in water. For use of said dispersions as protective colloid, it is advantageous that the pH of the oil-in-water emulsion is adjusted with an acid to a pH from 2 to 7. At pH 9.3, preferred colloidal dispersions of silica have a specific surface area in the range from 70 to 90 m²/g.

Preferred SiO₂-based protective colloids are fine-particle silicas having mean particle sizes in the range from 40 to 150 nm at pHs in the range from 8 to 11. Examples that may be mentioned are Levasil® 50/50 (H. C. Starck), Köstrosol® 3550 (CWK Bad Köstritz), and Bindzil® 50/80 (Akzo Nobel Chemicals).

In one preferred embodiment, a combination of an SiO₂-based protective colloid and of a methylhydroxy-(C₁-C₄)-alkylcellulose is used. It has been found here that the combination with a low-molecular-weight methylhydroxy-(C₁-C₄)-alkylcellulose leads to advantageous properties. The invention uses a methylhydroxy-(C₁-C₄)-alkylcellulose with an average (weight average) molar mass ≦50 000 g/mol, preferably in the range from 5000 to 50 000 g/mol, with preference from 10 000 to 35 000 g/mol, in particular from 20 000 to 30 000 g/mol.

The amounts generally used of the protective colloids are from 0.1 to 25% by weight, preferably from 0.1 to 20% by weight, preferably from 0.5 to 15% by weight, based on the entirety of lipophilic substance and monomers.

For inorganic protective colloids here it is preferable to select amounts of from 0.5 to 20% by weight, preferably from 0.5 to 18% by weight, based on the entirety of lipophilic substance and monomers.

The production process for the microcapsules to be used in the invention is well known and is described by way of example in DE-A-10 139 171, and application WO 2011/004006, and WO 2012/110443, expressly incorporated herein by way of reference.

In this way it is possible to produce microcapsules with a mean particle size in the range from 0.5 to 50 μm, where the particle size can be adjusted in a manner known per se by way of the shear force, the speed of stirring, and the concentration. Preference is given to microcapsules with a mean particle size in the range from 0.5 to 50 μm, preferably from 0.5 to 20 μm, in particular from 1 to 10 μm, in particular from 3 to 7 μm (volume mean D[4,3], determined by means of light scattering in a Malvern Mastersizer 2000, Hydro 2000S sample dispersion unit).

The present invention further comprises the process for producing the particulate microcapsule compositions by means of spray-drying. The spray-drying of the microcapsule dispersion can take place conventionally. The procedure is generally such that the ingoing temperature of the drying gas, generally nitrogen or air, is in the range from 100 to 200° C., preferably from 120 to 160° C., and the outgoing temperature of the drying gas is in the range from 30 to 90° C., preferably from 60 to 80° C. The spraying of the aqueous microcapsule dispersion within the drying gas stream can by way of example be achieved by means of single- or multifluid nozzles, or by way of a rotating disk. The droplet size discharged is selected in such a way as to produce a microcapsule powder in which the mean size of the powder particles is in the range from 100 to 400 μm and the size of 80% by weight of the particles is ≧90 μm. The person skilled in the art will consider the viscosity of the microcapsule dispersion when selecting the diameter of the nozzle and the admission pressure of the stream of material. The higher the admission pressure, the smaller the droplets produced. The pressure at which the microcapsule dispersion is fed into the system is usually from 2 to 200 bar. It is preferable to use a single-fluid nozzle with swirl generator. Droplet size and spray angle can also be influenced by way of the selection of the swirl generator. By way of example, single-fluid nozzles from Delavan can be used, and have a typical structure composed of swirl chamber, which influences the spray angle, and perforated plate, which influences throughput.

The particulate microcapsule composition is normally collected by using cyclones or filter collectors. The sprayed aqueous microcapsule dispersion and the drying gas stream are preferably conducted in parallel. It is preferable that the drying gas stream is injected cocurrently with the microcapsule dispersion into the tower from above.

In one process variant it is possible to install a fluidized bed downstream of the dryer in order to extract any residual moisture. Preference is given to processes in which the spray-drying process is followed by fluidized-bed drying, since they give a microcapsule composition with lower fines content.

By way of example, dryers from the companies Anhydro, Miro or Nubilosa, with tower heights of from 12 to 30 meters and widths of from 3 to 8 meters, can be used as spray tower. The throughput of drying gas for spray towers of this type is typically in the range from 20 to 30 t/h. The throughput of microcapsule dispersion is then generally from 1 to 1.5 t/h.

The invention uses an emulsion polymer which comprises, in copolymerized form,

from 50 to 99.9% by wt. of esters of acrylic and/or methacrylic acid with alkanols having from 1 to 12 carbon atoms and/or styrene, or

from 50 to 99.9% by wt. of styrene and/or butadiene, or

from 50 to 99.9% by wt. of vinyl chloride and/or vinylidene chloride, or

from 50 to 99.9% by wt. of vinyl acetate, vinyl propionate, vinyl esters of versatic acid, vinyl esters of long-chain fatty acids, and/or ethylene,

present in aqueous dispersion, as spraying aid.

The total amount of emulsion polymer (calculated as solid) added to the aqueous microcapsule dispersion prior to or during, but in particular prior to, the spray-drying process is from 1 to 40 parts by weight, often from 1 to 25 parts by weight, and frequently from 5 to 25 parts by weight, based in each case on 100 parts by weight of the microcapsules present in the aqueous dispersion and requiring spray-drying.

Emulsion polymers are familiar to the person skilled in the art and are produced by way of example in the form of an aqueous polymer dispersion via free-radical-initiated aqueous emulsion polymerization of ethylenically unsaturated monomers. There have been many previous descriptions of this method, which is therefore well known to the person skilled in the art. Aqueous polymer dispersions are moreover obtainable commercially, e.g. with trademarks ACRONAL®, STYRONAL®, BUTOFAN®, STYROFAN®, and KOLLICOAT® from BASF-SE, Ludwigshafen, Germany, VINNOFIL® and VINNAPAS® from Wacker Chemie-GmbH, Burghausen, and RHODIMAX® from Rhodia S.A.

The usual method for free-radical-initiated aqueous emulsion polymerization involves dispersing the ethylenically unsaturated monomers in an aqueous medium, generally with concomitant use of dispersing agents, such as emulsifiers and/or protective colloids, and polymerizing the mixture by using at least one water-soluble free-radical polymerization initiator. In methods frequently used, the residual content of unreacted ethylenically unsaturated monomers in the resultant aqueous polymer dispersions is reduced by chemical and/or physical methods likewise known to the person skilled in the art, polymer solids content is adjusted to a desired value by dilution or concentration, or other conventional additional substances, such as bactericidal, foam-modifying, or viscosity-modifying additives, are added to the aqueous polymer dispersion.

The invention can in particular advantageously use emulsion polymers which comprise, in copolymerized form, from 50 to 99.9% by weight of vinyl acetate and/or ethylene, in aqueous dispersion.

Particularly advantageous emulsion polymers are those which comprise, in copolymerized form,
from 0.1 to 5% by wt. of at least one α,β-monoethylenically unsaturated mono- and/or dicarboxylic acid having from 3 to 6 carbon atoms and/or amide thereof and
from 50 to 99.9% by wt. of at least one ester of acrylic and/or methacrylic acid with alkanols having from 1 to 12 carbon atoms and/or styrene,
   or
from 0.1 to 5% by wt. of at least one α,β-monoethylenically unsaturated mono- and/or dicarboxylic acid having from 3 to 6 carbon atoms and/or amide thereof and
from 50 to 99.9% by wt. of styrene and/or butadiene,
   or
from 0.1 to 5% by wt. of at least one α,β-monoethylenically unsaturated mono- and/or dicarboxylic acid having from 3 to 6 carbon atoms and/or amide thereof and
from 50 to 99.9% by wt. of vinyl chloride and/or vinylidene chloride,
   or
from 0.1 to 5% by wt. of at least one α,β-monoethylenically unsaturated mono- and/or dicarboxylic acid having from 3 to 6 carbon atoms and/or amide thereof and
from 50 to 99.9% by wt. of vinyl acetate, vinyl propionate, vinyl esters of versatic acid, vinyl esters of long-chain fatty acids, and/or ethylene,

in aqueous dispersion.

Very particular preference is given to emulsion polymers which comprise, in copolymerized form,

from 0.1 to 5% by wt. of at least one α,β-monoethylenically unsaturated mono- and/or dicarboxylic acid having from 3 to 6 carbon atoms and/or amide thereof and

from 50 to 99.9% by wt. of vinyl acetate, and/or ethylene,

in aqueous dispersion.

Examples of α,β-monoethylenically unsaturated mono- and/or dicarboxylic acids having 3 to 6 carbon atoms include acrylic acid, methacrylic acid, itaconic acid and the amides thereof, such as acrylamide and methacrylamide.

Esters of acrylic acid and/or methacrylic acid with alkanols having 1 to 12 carbon atoms be especially methyl, ethyl, n-propyl, isopropyl, n-butyl, isobutyl, sec-butyl and tert-butyl acrylate and the corresponding methacrylates. Likewise preferred C₁-C₁₂-alkyl esters of acrylic acid are ethyl acrylate, n-butyl acrylate, tert-butyl acrylate, n-hexyl acrylate and 2-ethylhexyl acrylate.

The ethylene content of the preferred aqueous vinyl acetate-ethylene dispersions is from 5 to 40% by weight, based on the polymer. If other monomers are used alongside vinyl acetate and ethylene, the vinyl acetate content of the polymer is advantageously above 45% by weight. Other monomers that can be used are olefinically unsaturated monomers, such as vinyl ethers of straight-chain or branched carboxylic acids having from 3 to 18 carbon atoms, acrylic, methacrylic, maleic, or fumaric esters of aliphatic alcohols having from 1 to 18 carbon atoms, vinyl chloride, and also isobutylene or higher a-olefins having from 4 to 12 carbon atoms. Examples of suitable monomer combinations other than vinyl acetate and ethylene are vinyl acetate/vinyl pivalate/ethylene, vinyl acetate/vinyl 2-ethylhexanoate/ethylene, vinyl acetate/methyl methacrylate/ethylene, and vinyl acetate/vinyl chloride/ethylene, from the group of what are known as terpolymers. Advantageous monomer combinations are those where the minimum film-forming temperature of the corresponding dispersions is ≧16° C. The materials can also comprise, in copolymerized form, at a concentration of up to 5% by weight, based on emulsion polymer, stabilizing monomers other than the monomers mentioned, for example the sodium salt of vinylsulfonic acid, carboxylated monomers, such as acrylic, methacrylic, crotonic, or itaconic acid, or monoesters of maleic acid where the alcohol component of these has from 1 to 18 carbon atoms.

Preference is given to aqueous dispersions of emulsion polymers of which the minimum film-forming temperature is ≧16° C.

It is preferable in the invention to use emulsion polymers with glass transition temperature ≧16 and ≦40° C., in particular ≧16 and ≦30° C., and advantageously ≧18 and ≦25° C. The expression “glass transition temperature (Tg)” means the limiting value of the glass transition temperature, where said temperature tends toward this value as molecular weight increases, in accordance with G. Kanig (Kolloid-Zeitschrift & Zeitschrift für Polymere, volume 190, page 1, equation 1). The glass transition temperature is determined by the DSC method (Differential Scanning Calorimetry, 20 K/min, midpoint measurement, DIN 53 765).

According to Fox (T. G. Fox, Bull. Am. Phys. Soc. 1956 [ser. II] 1, p. 123, and in Ullmann's Encyclopädie der technischen Chemie [Ullmann's Encyclopedia of Industrial Chemistry], volume 19, p. 18, 4th edition, Verlag Chemie, Weinheim, 1980) the following is a good approximation for the glass transition temperature of at most weakly crosslinked copolymers:

1/Tg=x1/Tg1+x2/Tg2+xn/Tgn,

where x1, x2, . . . xn are the mass fractions of the monomers 1, 2, . . . n, and Tg1, Tg2, . . . Tgn are the glass transition temperatures of the respective polymers composed solely of one of the monomers 1, 2, . . . n in degrees Kelvin. The Tg values for the homopolymers of most monomers are known and are listed by way of example in Ullmann's Encyclopedia of Industrial Chemistry, 5th edn., vol. A21, p. 169, Verlag Chemie, Weinheim, 1992; examples of other sources for glass transition temperatures of homopolymers are: J. Brandrup, E.H. Immergut, Polymer Handbook, 1st edn., J. Wiley, New York, 1966; 2nd edn., J.Wiley, New York, 1975, and 3rd edn., J. Wiley, New York, 1989.

In the form of solid, the emulsion polymers used in the invention preferably have a melting point in the range from 105 to 200° C.

The mean diameter of the emulsion polymers (polymer particles) present in aqueous dispersion is generally in the range from 10 to 500 nm, often from 50 to 300 nm, or from 80 to 200 nm. The solids contents of the aqueous dispersions that can be used in the invention, comprising emulsion polymers, are moreover generally ≧10 and ≦70% by weight, advantageously ≧30 and ≦70% by weight, and in particular advantageously ≧40 and ≦60% by weight.

Aqueous emulsion polymer dispersions and vinyl acetate-ethylene dispersions are well known and are described by way of example in DE 2214410, the disclosure of which is expressly incorporated herein by way of reference.

The aqueous emulsion polymer dispersion can be used directly as spraying aid in the form of the aqueous dispersion resulting from the synthesis. They are advantageously used in the form of dispersions of strength from 45 to 65% by weight.

The particulate microcapsule compositions obtained via spray-drying are particles which are generally composed of from two to several thousand individual capsules bonded to one another via the emulsion polymer.

The mean particle size D[4,3] of the particulate microcapsule compositions obtained in the invention is preferably in the range from 50 to 200 μm, preferably from 50 to 150 μm.

The present invention provides particulate microcapsule compositions comprising the abovementioned microcapsules and an emulsion polymer, where the glass transition temperature of the emulsion polymer is ≧6° C., and the mean particle size D[4,3] of the particulate microcapsule composition is from 50 to 200 μm, and the mean particle size D[4,3] of the microcapsules is from 1 to 10 μm.

In one preferred embodiment, the proportion of microcapsules, based on the particulate microcapsule composition, is from 80 to 95% by weight. Particulate microcapsule compositions of this type can by way of example be produced by means of spray-drying.

The particulate microcapsule compositions of the invention can advantageously be incorporated within thermoplastics. It is particularly preferable that the particulate microcapsule compositions of the invention are incorporated within thermoplastics in an extruder or in an injection-molding machine for producing thermoplastic moldings. To the extent that the intention is not to begin by obtaining the thermoplastically processable molding composition in the form of granulate, but instead is direct further processing of same, it is also advantageous to carry out the further processing while the material is hot, or to carry out direct extrusion of sheets, foils, tubes, and profiles, or direct production of plastics components.

The particulate microcapsule compositions can be advantageously processed under the processing conditions for the thermoplastic polymers, which generally involve temperatures above 105° C. Good, uniform dispersion of the individual microcapsules within the thermoplastic polymer can be observed, since the emulsion polymer of the composition becomes uniformly dispersed within the thermoplastic, and the extent to which the microcapsules are present in the form of individual capsules is markedly better than when microcapsule compositions of the prior art are used.

The properties of the thermoplastic can be modified by varying the lipophilic substance. To the extent that the lipophilic substance involves latent heat accumulator materials, the article produced therewith can be provided with heat-accumulating properties and properties that react to the temperature in the environment of the article. Latent-heat-accumulating materials are defined as substances which exhibit a phase transition in the temperature range within which heat transfer is intended to take place. The selection of the latent heat accumulator materials depends on the temperature range within which heat-accumulation is desired.

Preferred latent heat accumulator materials are aliphatic hydrocarbons, particular preference being given to those listed above by way of example. Particular preference is given to aliphatic hydrocarbons having from 14 to 20 carbon atoms, and also to mixtures of these.

Suitable thermoplastic materials into which the particulate microcapsule compositions can be incorporated are:
polyolefins, such as polyethylene (PE) and polypropylene (PP),
polyoxymethylene (POM),
polyvinyl chloride (PVC),
styrene polymers, such as polystyrene (impact-modified or not impact-modified),
impact-modified vinylaromatic copolymers, such as ABS (acrylonitrile-butadiene-styrene), ASA (acrylonitrile-styrene-acrylate), and MABS (transparent ABS, comprising methacrylate units),
styrene-butadiene block copolymers (“SBS”), in particular thermoplastic elastomers based on styrene (“S-TPE”),
polyamides,
polyesters, such as polyethylene terephthalate (PET), polyethylene terephthalate glycol (PETG), and polybutylene terephthalate (PBT),
polycarbonate,
polymethyl methacrylate (PMMA),
poly(ether) sulfones,
polyphenylene oxide (PPO)
thermoplastic polyurethanes (TPU)
ethylene-butyl acrylate (E/BA) and ethylene-ethyl acrylate (E/EA)
ethylene-vinyl acetate copolymers (E/VA)
polyvinyl acetate (PVAc), and
polyisobutylene (PIB).

Particularly good dispersion of the microcapsules can be found here when the emulsion polymer and the thermoplastic material into which the microcapsules are to be incorporated comprise the same main monomers.

It is particularly preferable that the thermoplastics involve polyolefins or polyolefin copolymers.

The microcapsule compositions of the invention are moreover suitable as addition in polymeric moldings or polymeric coating compositions. These are thermoplastics that can be processed without destroying the microcapsules. The microcapsule compositions are moreover also suitable for incorporation into plastics foams. Examples of foams are polyurethane foam, polystyrene foam, latex foam, and melamine-resin foam.

The particle size of the microcapsule dispersion is determined with a Malvern Mastersizer 2000 with Hydro 2000S sample dispersion unit in accordance with a standard measurement method documented in the literature. The D[4,3] value is the volume mean value.

The examples which follow are intended to illustrate the invention in detail. The percentages in the examples are % by weight unless stated otherwise.

### EXAMPLES

A) Production of the Microcapsule Dispersion

Water Phase:

680 g of water

165 g of a 50% by weight silica sol (specific surface area about 80 m²/g)

8 g of a 5% by weight aqueous solution of methyl hydroxypropyl cellulose having a mean molecular weight of 26 000 g/mol

2.1 g of a 2.5% by weight aqueous sodium nitrite solution

2.7 g of a 20% by weight nitric acid solution in water

Oil Phase

440 g of a paraffin mixture having a melting point of 23° C.

66.0 g of methyl methacrylate

44.0 g of pentaerythrityl tetraacrylate (technical grade, from Cytec)

Addition 1

1.5 g of a 75% solution of t-butyl perpivalate in aliphatic hydrocarbons

1.1 g of water

Feed 1:

22.0 g of a 5% by weight aqueous sodium peroxodisulfate solution

30.0 g of water

The water phase was initially charged, to which was added, at 40° C., the molten and homogeneously mixed oil phase, and this was dispersed with a high-speed dissolverstirrer (disk diameter 5 cm) at 3500 rpm for 40 minutes. Addition 1 was added. While stirring with an anchor stirrer, the emulsion was heated to 67° C. within 60 minutes and to 90° C. within a further 60 minutes, and kept at 90° C. for 150 minutes. Feed 1 was metered into the resultant microcapsule dispersion at 90° C. over the course of 90 minutes while stirring, and then the mixture was stirred at this temperature for 60 minutes. Then the mixture was cooled to room temperature. A microparticle dispersion having a mean particle size of D[4,3]=5.1 μm was obtained.

B) Production of the Particulate Microcapsule Composition

The following were metered successively into the aqueous microcapsule dispersion obtained according to A): first 24.3 g of a copolymer of vinyl chloride, ethylene, vinyl ester and acrylate (from Wacker Polymers), then 3.7 g of a 25% by weight aqueous sodium hydroxide solution and finally 10.6 g of a 30% by weight aqueous Sokalan AT 120 solution. The dispersion thus obtained was dried with a laboratory spray drier (cylinder diameter 250 mm, cylinder length 500 mm) to obtain a powder. For this purpose, the dispersion was atomized with a two-phase nozzle (1.4 mm nozzle, nozzle pressure 3 bar). The drying gas (nitrogen) was conducted into the spray cylinder from above in cocurrent with the sprayed microcapsule dispersion. The drying gas had an inlet temperature of 150° C. and an outlet temperature of 80° C. A particulate microcapsule composition (cyclone discharge) having a particle size D[4,3]=5.7 μm was obtained.

1. A particulate microcapsule composition, comprising:
microcapsules and
an emulsion polymer,
wherein
the particulate microcapsule composition is obtained via spray drying of an aqueous microcapsule dispersion,
the microcapsules comprise a capsule core and a polymer as capsule wall and the polymer comprises
from 30 to 90% by wt. of at least one monomer I of a C₁-C₂₄-alkyl ester of acrylic and/or methacrylic acid, acrylic acid, methacrylic acid, and maleic acid,
from 10 to 70% by wt. of at least one monomer II of an ethylenically unsaturated monomer comprising two, three, four, or more ethylenically unsaturated moieties, and
from 0 to 40% by wt. of at least one monomers III,
based in each case on a total weight of the monomers, and
a spraying aid is used in the spray drying which is an aqueous dispersion of at least one emulsion polymer which comprises in copolymerized form
from 50 to 99.9% by wt. of an ester of acrylic and/or methacrylic acid with an alkanol comprising from 1 to 12 carbon atoms and/or styrene, or
from 50 to 99.9% by wt. of styrene and/or butadiene, or
from 50 to 99.9% by wt. of vinyl chloride and/or vinylidene chloride, or
from 50 to 99.9% by wt. of vinyl acetate, vinyl propionate, a vinyl ester of versatic acid, a vinyl ester of a long-chain fatty acid, and/or ethylene.

2. The particulate microcapsule composition according to claim 1, wherein a mean particle size D[4,3] of the microcapsules is from 1 to 10 μm.

3. The particulate microcapsule composition according to claim 1, wherein the spraying aid comprises, in copolymerized form, an aqueous dispersion of an emulsion polymer which comprises from 50 to 99.9% by weight of vinyl acetate and/or ethylene.

4. The particulate microcapsule composition according to claim 1, wherein the spraying aid comprises an aqueous dispersion of an emulsion polymer and a minimum film-forming temperature of this dispersion is ≧16° C.

5. The particulate microcapsule composition according to claim 1, wherein the spraying aid comprises an aqueous dispersion of an emulsion polymer and the emulsion polymer has a glass transition temperature of from ≧16° C. to ≦40° C.

6. The particulate microcapsule composition according to claim 1, wherein the spraying aid comprises an aqueous dispersion of an emulsion polymer and the emulsion polymer has a melting point of from 105 to 200° C.

7. The particulate microcapsule composition according to claim 1, which has a mean particle size D[4,3] of from 50 to 200 μm.

8. A process for producing the particulate microcapsule composition according to claim 1, the process comprising:
spray-drying the aqueous microcapsule dispersion with the aqueous dispersion of the emulsion polymer as the spraying aid.

9. The process according to claim 8, wherein a sprayed aqueous dispersion of the emulsion polymer and a drying gas stream are conducted in parallel.

10. A particulate microcapsule composition, comprising:
microcapsules and
an emulsion polymer,
wherein
the microcapsules comprise a capsule core and a polymer as capsule wall and the polymer comprises
from 30 to 90% by wt. of at least one monomer I of a C₁-C₂₄-alkyl ester of acrylic and/or methacrylic acid, acrylic acid, methacrylic acid, and maleic acid,
from 10 to 70% by wt. of at least one ethylenically unsaturated monomer II comprising two, three, four, or more ethylenically unsaturated moieties, and
from 0 to 40% by wt. of at least one monomers III,
based in each case on a total weight of the monomers,
the emulsion polymer comprises, in copolymerized form,
from 50 to 99.9% by wt. of an ester of acrylic and/or methacrylic acid with an alkanol comprising from 1 to 12 carbon atoms and/or styrene, or
from 50 to 99.9% by wt. of styrene and/or butadiene, or
from 50 to 99.9% by wt. of vinyl chloride and/or vinylidene chloride, or
from 50 to 99.9% by wt. of vinyl acetate, vinyl propionate, a vinyl ester of versatic acid, a vinyl ester of a long-chain fatty acid, and/or ethylene,
and has a glass transition temperature of ≧16° C.,
the particulate microcapsule composition has a mean particle size D[4,3] of from 50 to 200 μm, and
the microcapsules has a mean particle size D[4,3] of from 1 to 10 μm.

11. A method for producing a thermoplastic molding, the method comprising:
incorporating the particulate microcapsule composition according to claim 1 with thermoplastics in an extruder or an injection molding machine.

12. The method according to claim 11, wherein the thermoplastic comprises a polyolefin or a polyolefin copolymer.

13. The method according to claim 11, wherein the thermoplastic molding is a sheet, a foil, a tube, a profile, or a plastics component.
